(19) United States
(12) Patent Application Publication
(10) Pub. No.: US 2026/0222788 A1
(43) Pub. Date: Jul. 30, 2026

(54) COMMUNICATION METHOD, ELECTRONIC DEVICE, AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 19/148,924

(22) PCT Filed: Jan. 17, 2023
(86) PCT No.: PCT/CN2023/072739

§ 371 Date: Jul. 17, 2025

(51) Int. Cl. H04W 8/00; H04W 60/04

(52) U.S. Cl. CPC H04W 8/005; H04W 60/04

(57) ABSTRACT

A communication method and corresponding electronic device are disclosed for enabling relay-based data transmission in wireless communication systems. The method includes generating and transmitting a first radio frame that comprises first identification information, set as a parameter value to indicate that the transmitter intends to transmit a relay data frame over a first link. The first radio frame may also include a link present indicator and a relay discovery element, which may specify delay bound requirements. Upon transmission, a relay may receive the first radio frame and respond with a second radio frame that includes second identification information, identifying that the relay will transmit the relay data frame over a second link. The second radio frame may be a relay link response frame and include its own link present indicator. Additional radio frames may be generated to indicate support for relay operations during initial association.

### CROSS REFERENCE TO RELATED APPLICATIONS

This application is a US National Phase of a PCT Application No. PCT/CN2023/072739 filed on Jan. 17, 2023, the entire contents of which are incorporated herein by reference in their entirety.

### TECHNICAL FIELD

The embodiments of the present disclosure relate to the field of mobile communication technology, in particular to communication methods, electronic devices, and storage media.

### BACKGROUND

With the rapid development of mobile communication technology, Wireless Fidelity (Wi-Fi) technology has made tremendous progress in transmission speed and throughput. At present, in Wi-Fi technology, topics such as Ultra High Reliability (UHR) is researched, with the vision of improving the reliability of Wireless Local Area Networks (WLAN) connectivity, reducing latencies, increasing manageability, increasing throughput at different Signal to Noise Ratio (SNR) levels, and reducing device level power consumption. Moreover, in UHR, in order to improve the system throughput, a method of communicating simultaneously in the sub7 GHZ (gigahertz) and 45 GHz and/or 60 GHz frequency bands is proposed.

In UHR, the transmission mechanism for low delay services will be further enhanced, and multi-link scenarios are supported. To enhance throughput at different levels of Signal to Noise Ratio (SNR), data relay may be used in UHR to transmit data frames. Therefore, it is necessary to provide an implementation method for data relay to meet the transmission requirements of UHR.

### SUMMARY

The embodiments of the present disclosure provide communication methods, electronic devices, and storage media to provide an implementation of data relay.

On the one hand, the embodiments of the present disclosure provide a communication method performed by a transmitter, including:
determining a first radio frame, where the first radio frame includes first identification information, where the first identification information is set as a first parameter value to identify that the transmitter requests to transmit a relay data frame in a first link; and transmitting the first radio frame.

On the other hand, the embodiments of the present disclosure further provide a communication method performed by a relay, including:
receiving a first radio frame, where the first radio frame includes first identification
information, where the first identification information is set as a first parameter value to identify that a transmitter requests to transmit a relay data frame in a first link.

On the other hand, the embodiments of the present disclosure further provide an electronic device, which is a transmitter, including:
a determining module, configured to determine a first radio frame, where the first radio frame includes first identification information, where the first identification information is set as a first parameter value to identify that the transmitter requests to transmit a relay data frame in a first link; and
a transmitting module, configured to transmit the first radio frame.

On the other hand, the embodiments of the present disclosure further provide an electronic device, which is a relay, including:
a receiving module, configured to receive a first radio frame, where the first radio frame includes first identification information, where the first identification information is set as a first parameter value to identify that a transmitter requests to transmit a relay data frame in a first link.

The embodiments of the present disclosure further provide an electronic device including a memory, a processor, and a computer program stored on the memory and executable on the processor. The processor executes the program, to implement the method described in one or more of the embodiments of the present disclosure.

The embodiments of the present disclosure further provide a computer-readable storage medium on which a computer program is stored. The computer program is executed by a processor, to implement the method described in one or more of the embodiments of the present disclosure.

In the embodiments of the present disclosure, the transmitter determines and transmits the first radio frame, where the first radio frame includes the first identification information, where the first identification information is set as a first parameter value to identify that the transmitter requests to transmit a relay data frame in a first link. The embodiments of the present disclosure provide an implementation method for data relay to meet the transmission requirements of UHR.

The additional aspects and advantages of the embodiments of the present disclosure will be partially presented in the following description, which will become apparent from the following description or learned through practice of the present disclosure.

### BRIEF DESCRIPTION OF DRAWINGS

In order to more clearly illustrate the technical solutions according to the embodiments of the present disclosure, drawings that need to be used in the description of the embodiments will be briefly introduced below. The drawings in the following description only relate to some embodiments of the present disclosure. For those skilled in the art, other drawings can also be obtained according to these drawings without creative effort.

FIG. 1 is the first flowchart of a communication method provided in the embodiments of the present disclosure.

FIG. 2 is the first schematic diagram of the first example of the embodiments of the present disclosure.

FIG. 3 is the second schematic diagram of the first example of the embodiments of the present disclosure.

FIG. 4 is the third schematic diagram of the first example of the embodiments of the present disclosure.

FIG. 5 is a schematic diagram of the second example of the embodiments of the present disclosure.

FIG. 6 is the second flowchart of the communication method provided in the embodiments of the present disclosure.

FIG. 7 is the first schematic structural diagram of an electronic device provided in the embodiments of the present disclosure.

FIG. 8 is the second schematic structural diagram of an electronic device provided in the embodiments of the present disclosure.

FIG. 9 is the third schematic structural diagram of an electronic device provided in the embodiments of the present disclosure.

### DETAILED DESCRIPTION

Embodiments will be described in detail herein, examples of which are illustrated in the accompanying drawings. Where the following description refers to the drawings, elements with the same numerals in different drawings refer to the same or similar elements unless otherwise indicated. Implementations described in the following embodiments do not represent all implementations consistent with the present disclosure. On the contrary, they are examples of an apparatus and a method consistent with some aspects of the present disclosure described in detail in the appended claims.

The term used in the embodiments of the present disclosure is for the purpose of describing particular examples only and is not intended to limit the present disclosure. As used in the present disclosure and the appended claims, the singular forms “a,” “an” and “the” are intended to include the plural forms as well, unless the context clearly indicates otherwise. It should further be understood that the term “and/or” as used herein refers to and includes any and all possible combinations of one or more of the associated listed items. For example, A and/or B can represent three situations of A alone, A and B simultaneously, and B alone. The character “/” generally indicates that the associated objects before and after “/” are in an “or” relationship. The term “a plurality of” refers to two or more, and therefore, in the embodiments of the present disclosure, “a plurality of” can also be understood as “at least two”.

It should be understood that although the terms first, second, third, etc. may be used in the present disclosure to describe various information, such information should not be limited to these terms. These terms are only used to distinguish the same type of information from each other. For example, without departing from the scope of the present disclosure, the first information may also be referred to as the second information, and similarly, the second information may also be referred to as the first information. Depending on the context, the word “if” as used herein can be interpreted as “at the time of,” “when” or “in response to determining”.

The technical solutions in the embodiments of the present disclosure are clearly described below with reference to the accompanying drawings in the embodiments of the present disclosure. The embodiments described are merely some embodiments of the present disclosure, and not all embodiments. Other embodiments achieved by those skilled in the art according to the embodiments in the present disclosure without paying creative work shall all fall within the scope of protection of the present disclosure.

The embodiments of the present disclosure provide communication methods, electronic devices, and storage media to provide an implementation of data relay.

Where the methods and apparatuses are based on the same application concept. Since the problem-solving principles of the methods and apparatuses are similar, the implementation of the apparatuses and the implementation of methods can be referred to each other, which will not be repeated.

As shown in FIG. 1, the embodiments of the present disclosure provide a communication method, which can be optionally performed by a transmitter, where the transmitter can be a station (STA). Optionally, in the embodiments of the present disclosure, the relay may be an Access Point (AP) or an STA, where the AP, such as a device with wireless to wired bridging function, is responsible for extending the services provided by the wired network to the wireless network; the Station device (STA), such as an electronic device with wireless network access function, provides frame delivery services to facilitate the transmission of information.

The method may include the following steps 101 and 102.

In step 101, a first radio frame is determined, where the first radio frame includes first identification information, where the first identification information is set as a first parameter value to identify that the transmitter requests to transmit a relay data frame in a first link.

In a wireless local area network, a Basic Service Set (BSS) can consist of an AP and one or more stations (STAs) communicating with the AP. A basic service set can be connected to a Distribution System (DS) through the AP of the basic service set, and then connected to another basic service set to form an Extended Service Set (ESS). As a first example, AP1 and STA1 form BSS1, and AP2 and STA2 form BSS2. Coverages of two or more BSSs overlap to form an Overlapping Basic Service Set (OBSS). For example, BSS1 and BSS2 overlap to form an OBSS.

Optionally, in the embodiments of the present disclosure, AP and STA can be devices that support multiple links. For example, the AP and the STA can be respectively represented as AP MLD (multi-link device) and non-AP MLD. AP MLD can represent an access point that supports multi-link communication functionality, and non-AP MLD can represent a station that supports multi-link communication functionality.

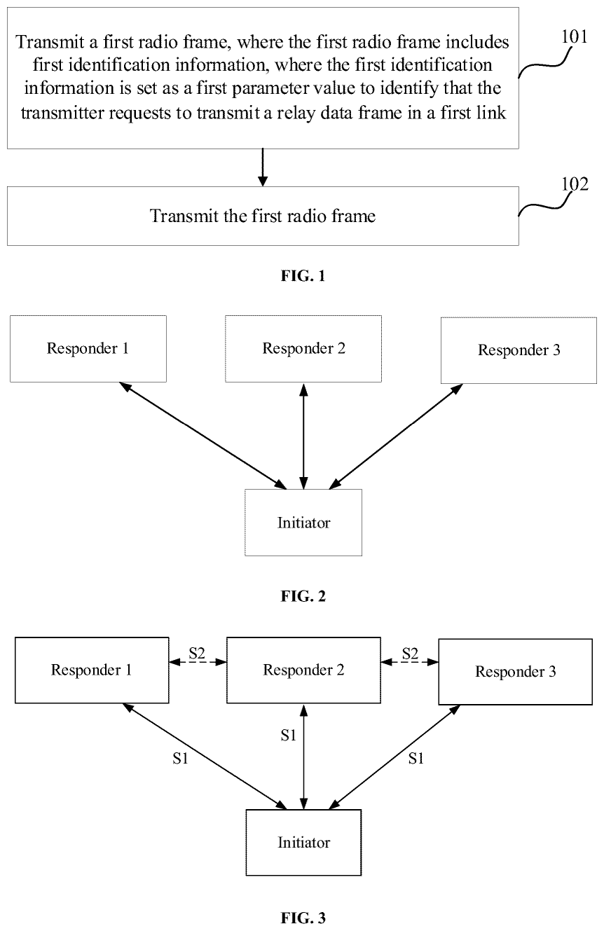

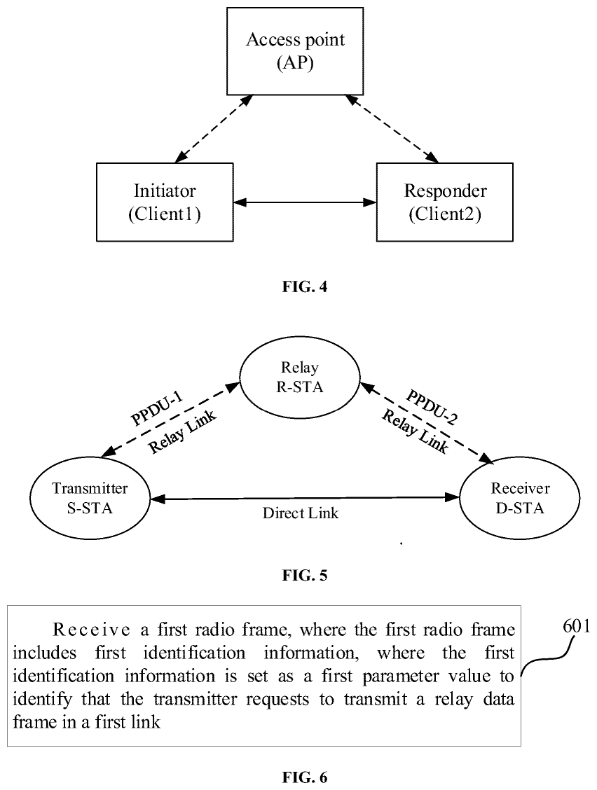

AP MLD can include three affiliated APs, such as AP1, AP2, and AP3 shown in FIG. 3. The APs can operate respectively on Link 1, Link 2, and Link 3. Non-AP MLD can also include three affiliated STAs, such as STA1, STA2, and STA3 shown in FIG. 2. STA1 works on Link 1, STA2 works on Link 2, and STA3 works on Link 3.

For ease of description, in the following text, an example of communication between one AP and one STA under multiple links will be mainly described, which is not limited in the embodiments of the present disclosure. In the example of FIG. 3, assuming that AP1 and STA1 communicate through the corresponding first link Link 1, similarly, AP2 and STA2 communicate through the corresponding second link Link 2, and AP3 communicates with STA3 through the third link Link 3. In addition, Link 1 to Link 3 can be links at different frequencies, such as links at 2.4 GHZ, 5 GHZ, 6 GHZ, or can be several links with the same or different bandwidths at 2.4 GHz. In addition, there can be multiple channels under each link. It can be understood that the communication scenario shown in FIG. 2 is only exemplary, and the concept of the present disclosure is not limited to this. For example, an AP MLD can be connected to multiple (such as three) non-AP MLDs, or at each link, the AP can communicate with multiple other types of stations.

In UHR, data frames can be transmitted using a data relay method. As a second example, referring to FIG. 5, during the process of data relay transmission, the transmitter (Source STA, S-STA) transmits a relay data frame, such as PPDU-1 (Physical Layer Protocol Data Unit-1), to the relay (Relay STA, R-STA) through a relay link. After the relay fills the necessary address into the relay data frame, the relay forwards the relay data frame (such as PPDU-2) to the receiver (Destination STA, D-STA). In addition, the transmitter can also transmit data frames between the transmitter and the receiver through a direct link. In the embodiments of the present disclosure, the relay can also be an AP. For ease of explanation, STA will be introduced as the relay in the following, which does not constitute a limitation on the embodiments of the present disclosure.

During the data relay process, the Source STA determines the first radio frame, where the first identification information is included in the first radio frame. The first identification information, such as the Link Bitmap flag, is configured to identify whether the transmitter requests to use the Link corresponding to the Link Bitmap flag as the Relay Link. For example, The value of the first identification information being set to the first parameter value (where the first parameter value is 1) identifies that the transmitter requests to transmit a relay data frame under the first link corresponding to the first identification information; and the value of the first identification information being set to 0 identifies that the transmitter does not request to transmit the relay data frame under the first link corresponding to the first identification information.

For example, the transmitter can select a link with a higher transmission rate as the first link to transmit the relay data frame. Since in UHR, devices may support multi-link communication functionality, each link can serve as a relay link, and the maximum or minimum rate on each link may vary. Therefore, the transmission delay on each link is also different. To ensure the transmission delay of UHR services, the transmitter can select a Link with a better transmission rate as the Relay Link. For example, the transmitter can select the Link with the highest maximum rate value as the Relay Link; or select the Link with the highest minimum rate value as the Relay Link.

In addition, the transmitter can also request multiple first links simultaneously, i.e., set the first identification information of multiple links as the first parameter value, such that the relay can select a target link to transmit the relay data frame. It can be understood that the relay can select the target link as the relay link from multiple first links, or the relay may not select from the first links. For example, if the relay discovers a link with a higher transmission rate, the relay can prioritize selecting the link with the higher transmission rate as the relay link, which can improve the transmission rate and reduce the transmission delay.

In step 102, the first radio frame is transmitted.

Optionally, the first radio frame may be a Relay Link Discovery frame.

In the embodiments of the present disclosure, the transmitter determines and transmits the first radio frame, where the first radio frame includes the first identification information, where the first identification information is set as a first parameter value to identify that the transmitter requests to transmit a relay data frame in a first link. The embodiments of the present disclosure provide an implementation method for data relay to meet the transmission requirements of UHR.

The embodiments of the present disclosure provide a communication method, which can be optionally performed by the transmitter. The method includes:
determining a first radio frame, where the first radio frame includes first identification information, where the first identification information is set as a first parameter value to identify that the transmitter requests to transmit a relay data frame in a first link; and
transmitting the first radio frame.

Where the first radio frame includes a link present indicator, where the link present indicator indicates whether the first identification information (such as the Link Bitmap Present flag) is included in the first radio frame. The Link Bitmap Present flag being set to 1 indicates the presence of the first identification information (such as the Link Bitmap flag) in the first radio frame, to identify that the transmitter recommends the optional first link as the Relay Link.

The embodiments of the present disclosure provide a communication method, which can be optionally performed by the transmitter. The method includes:
determining a first radio frame, where the first radio frame includes first identification information, where the first identification information is set as a first parameter value to identify that the transmitter requests to transmit a relay data frame under a first link; where the first identification information is included in a Relay Discovery element; for example, both the Link Bitmap Present flag and the Link Bitmap flag are set in the Relay Discovery element; and transmitting the first radio frame.

The embodiments of the present disclosure provide a communication method, which can be optionally performed by the transmitter. The method includes:
determining a first radio frame, where the first radio frame includes first identification information, where the first identification information is set as a first parameter value to identify that the transmitter requests to transmit a relay data frame under a first link; where the first identification information is included in the relay discovery element, where the relay discovery element includes delay bound requirement; and transmitting the first radio frame.

Where the delay bound requirement can include the range values of transmission delay, which correspond one-to-one with each Link Bitmap, and are configured to select the link that meets the range of a transmission delay as the Relay Link. As a third example, the format of the relay discovery element is shown in Table 1 below.

TABLE 1
Bound

| | | | | |
|---|---|---|---|---|
| Information | Relay | UL/DL | Delay Bound | Link |
| Content | Discovery | (UpLink/Down | Requirement/ | Bitmap |
| | Control | Link) Data | Channel | (Optional) |
| | | Rate | Utilization | |
| | | (Optional) | (Optional) | |

Where the relay discovery element includes fields such as relay discovery control, UL/DL data rate, delay bound requirement/channel utilization, Link Bitmap, etc. It can be understood that when the relay discovery element is an element in the relay link discovery frame, the relay discovery element includes the Link Bitmap field. When the relay discovery element is an element in the relay link response frame, the relay discovery element may not include the Link Bitmap field.

In addition, if the transmitter is an STA, the relay discovery element of the relay link discovery frame only includes the UL Data Rate subfield. If the transmitter is an AP, the relay discovery element of the relay link discovery frame only includes the DL Data Rate subfield. For the DL Relay and the UL Relay that exist simultaneously, the uplink and downlink relay links may be the same or different.

The embodiments of the present disclosure provide a communication method, which can be optionally performed by the transmitter. The method further includes:
receiving a second radio frame transmitted by a relay; where the second radio frame includes second identification information; where the second identification information is set as a second parameter value to identify that the relay transmits the relay data frame in a second link.

Optionally, the second radio frame is, for example, a Relay Link Response frame, and in the Relay Link Response frame, the relay indicates that the link on which data relay is about to be performed is the second link. After receiving the second radio frame, the receiver can transmit a relay data frame to the relay in the second link.

The second identification information, such as the Link Bitmap flag, is configured to identify whether the Link corresponding to the second identification information is selected as a Relay Link by the relay. For example, when the value of the second identification information is set to the first parameter value, where the first parameter value is 1, the relay determines to transmit the relay data frame in the second link corresponding to the second identification information; and the value of the second identification information being set to 0 indicates that the relay does not transmit the relay data frame in the second link corresponding to the second identification information.

For example, the relay can select a link with a higher transmission rate as the first link to transmit the relay data frame. Since in UHR, devices may support multi-link communication functionality, each link can serve as a relay link, and the maximum or minimum rate on each link may vary. Therefore, the transmission delay on each link is also different. To ensure the transmission delay of UHR services, the relay can select a Link with a better transmission rate as the Relay Link. For example, the transmitter can select the Link with the highest maximum rate value as the Relay Link; or select the Link with the highest minimum rate value as the Relay Link.

In addition, the transmitter can also request multiple first links simultaneously, i.e., set the first identification information of multiple links as the first parameter value, such that the relay can select a target link to transmit the relay data frame. It can be understood that the relay can select the target link as the relay link from multiple first links, or the relay may not select from the first links. For example, if the relay discovers a link with a higher transmission rate, the relay can prioritize selecting the link with the higher transmission rate as the relay link, which can improve the transmission rate and reduce the transmission delay.

The embodiments of the present disclosure provide a communication method, which can be optionally performed by the transmitter. The method further includes:
receiving a second radio frame transmitted by a relay; where the second radio frame includes second identification information; where the second identification information is set as a second parameter value to identify that the relay transmits the relay data frame in a second link.

The second radio frame includes a link present indicator;
where the link present indicator indicates that the second radio frame includes the second identification information.

Where the second radio frame includes a link present indicator, where the link present indicator indicates whether the second identification information (such as the Link Bitmap Present flag) is included in the second radio frame. The Link Bitmap Present flag being set to 1 indicates the presence of the first identification information (such as the Link Bitmap flag) in the second radio frame, to identify that the relay determines the second link as the Relay Link.

The embodiments of the present disclosure provide a communication method, which can be optionally performed by the transmitter. The method further includes:
determining a third radio frame; where the third radio frame includes third identification information, where the third identification information identifies that the transmitter supports relay data frame transmission; and transmitting the third radio frame.

Optionally, the third radio frame can be a Beacon frame, a Probe Response frame, or a Probe Request frame. The transmitter includes third identification information in the third radio frame to indicate that the transmitter supports transmitting relay data frames in one or multiple links.

In an example, the method further includes:
activating a link that supports relay data frame transmission during initial association with a relay.

The transmitter activates the Relay Link during the initial association process with the relay. For example, all links established during the initial association process can be used as Relay links and activated, or a link mapped by Traffic Identifier-to-Link (TID-to-Link) can be used as the Relay link.

The embodiments of the present disclosure provide a communication method, which can be optionally performed by the transmitter. The method further includes:
determining a first radio frame, where the first radio frame includes first identification information, where the first identification information is set as a first parameter value to identify that the transmitter requests to transmit a relay data frame in a first link; and
transmitting the first radio frame.

Optionally, the first radio frame includes a link present indicator;
where the link present indicator indicates whether the first identification information is included in the first radio frame.

Optionally, the first identification information is included in a relay discovery element.

Optionally, the relay discovery element includes delay bound requirement.

Optionally, the first radio frame includes a relay link discovery frame.

In some embodiments, the method further includes:
receiving a second radio frame transmitted by a relay; where the second radio frame includes second identification information; where the second identification information is set as a second parameter value to identify that the relay transmits the relay data frame in a second link.

Optionally, the second radio frame includes a link present indicator;
where the link present indicator indicates that the second radio frame includes the second identification information.

Optionally, the second radio frame includes a relay link response frame.

In some embodiments, the method further includes:
determining a third radio frame; where the third radio frame includes third identification information, where the third identification information identifies that the transmitter supports relay data frame transmission; and
transmitting the third radio frame.

In some embodiments, the method further includes:
activating a link that supports relay data frame transmission during initial association with a relay.

In the embodiments of the present disclosure, the transmitter determines and transmits the first radio frame, where the first radio frame includes the first identification information, where the first identification information is set as a first parameter value to identify that the transmitter requests to transmit a relay data frame in a first link. The embodiments of the present disclosure provide an implementation method for data relay to meet the transmission requirements of UHR.

Referring to FIG. 6, the embodiments of the present disclosure provide a communication method, which can be optionally performed by a relay, where the relay can be connected to an AP or STA.

The method may include the following steps 601 and 602.

In step 601, a first radio frame is received, where the first radio frame includes first identification information, where the first identification information is set as a first parameter value to identify that the transmitter requests to transmit a relay data frame in a first link.

Where the architecture of the WLAN applied by the communication method provided in the embodiments of the present disclosure refers to the first example mentioned above, and will not be repeated here.

In UHR, data frames can be transmitted using a data relay method. As a second example, referring to FIG. 5, during the process of data relay transmission, the transmitter (Source STA, S-STA) transmits a relay data frame, such as PPDU-1 (Physical Layer Protocol Data Unit-1), to the relay (Relay STA, R-STA) through a relay link. After the relay fills the necessary address of the relay data frame, the relay forwards the relay data frame (such as PPDU-2) to the receiver (Destination STA, D-STA). In addition, the transmitter can also transmit data frames between themselves and the receiver through a direct link. In the embodiments of the present disclosure, the relay can also be an AP. For ease of explanation, STA will be introduced as the relay in the following, which does not constitute a limitation on the embodiments of the present disclosure.

During the data relay process, the Relay STA receives the first radio frame to obtain the first identification information included in the first radio frame. The first identification information, such as the Link Bitmap flag, is configured to identify whether the transmitter requests to use the Link corresponding to the Link Bitmap flag as the Relay Link. For example, The value of the first identification information being set to the first parameter value (where the first parameter value is 1) identifies that the transmitter requests to transmit a relay data frame under the first link corresponding to the first identification information; and the value of the first identification information being set to 0 identifies that the transmitter does not request to transmit the relay data frame under the first link corresponding to the first identification information.

For example, the transmitter can select a link with a higher transmission rate as the first link to transmit the relay data frame. Since in UHR, devices may support multi-link communication functionality, each link can serve as a relay link, and the maximum or minimum rate on each link may vary. Therefore, the transmission delay on each link is also different. To ensure the transmission delay of UHR services, the transmitter can select a Link with a better transmission rate as the Relay Link. For example, the transmitter can select the Link with the highest maximum rate value as the Relay Link; or select the Link with the highest minimum rate value as the Relay Link.

In addition, the transmitter can also request multiple first links simultaneously, i.e., set the first identification information of multiple links as the first parameter value, such that the relay can select a target link to transmit the relay data frame. It can be understood that the relay can select the target link as the relay link from multiple first links, or the relay may not select from the first links. For example, if the relay discovers a link with a higher transmission rate, the relay can prioritize selecting the link with the higher transmission rate as the relay link, which can improve the transmission rate and reduce the transmission delay.

Optionally, the first radio frame may be a Relay Link Discovery frame.

In the embodiments of the present disclosure, the relay STA receives the first radio frame to obtain the first identification information included in the first radio frame, where the first identification information is set as a first parameter value to identify that the transmitter requests to transmit a relay data frame under the first link. The embodiments of the present disclosure provide an implementation method for data relay to meet the transmission requirements of UHR.

The embodiments of the present disclosure provide a communication method, which can be optionally performed by the relay. The method may include the following steps:
receiving a first radio frame, where the first radio frame includes first identification information, where the first identification information is set as a first parameter value to identify that a transmitter requests to transmit a relay data frame in a first link.

Where the first radio frame includes a link present indicator, where the link present indicator indicates whether the first identification information (such as the Link Bitmap Present flag) is included in the first radio frame. The Link Bitmap Present flag being set to 1 indicates the presence of the first identification information (such as the Link Bitmap flag) in the first radio frame, to identify that the transmitter recommends the optional first link as the Relay Link.

The embodiments of the present disclosure provide a communication method, which can be optionally performed by the relay. The method may include the following steps:
receiving a first radio frame, where the first radio frame includes first identification information, where the first identification information is set as a first parameter value to identify that the transmitter requests to transmit a relay data frame under a first link; where the first identification information is included in a Relay Discovery element; for example, both the Link Bitmap Present flag and the Link Bitmap flag are set in the Relay Discovery element; and
where the first identification information is included in a relay discovery element.

The embodiments of the present disclosure provide a communication method, which can be optionally performed by the relay. The method may include the following steps:
receiving a first radio frame, where the first radio frame includes first identification information, where the first identification information is set as a first parameter value to identify that the transmitter requests to transmit a relay data frame under a first link; where the first identification information is included in the relay discovery element, where the relay discovery element includes delay bound requirement; and
Where the delay bound requirement can include the range values of transmission delay, which are configured to select the link that meets the range of a transmission delay as the Relay Link. Referring to Table 1 above, the relay discovery element includes fields such as relay discovery control, UL/DL data rate, delay bound requirement/channel utilization, Link Bitmap, etc. It can be understood that when the relay discovery element is an element in the relay link discovery frame, the relay discovery element includes the Link Bitmap field. When the relay discovery element is an element in the relay link response frame, the relay discovery element may not include the Link Bitmap field.

The embodiments of the present disclosure provide a communication method, which can be optionally performed by the relay. The method may include the following steps:
receiving a second radio frame transmitted by a relay; where the second radio frame includes second identification information, where the second identification information is set as a second parameter value to identify that the relay transmits the relay data frame in a second link.

The second radio frame is, for example, a Relay Link Response frame, and in the Relay Link Response frame, the relay indicates that the link on which the data delay is about to be performed is the second link. After receiving the second radio frame, the receiver can transmit a relay data frame to the relay in the second link.

The second identification information, such as the Link Bitmap flag, is configured to identify whether the Link corresponding to the second identification information is selected as a Relay Link by the relay. For example, when the value of the second identification information is set to the first parameter value, where the first parameter value is 1, the relay determines to transmit the relay data frame in the second link corresponding to the second identification information; and the value of the second identification information being set to 0 indicates that the relay does not transmit the relay data frame in the second link corresponding to the second identification information.

For example, the relay can select a link with a higher transmission rate as the first link to transmit the relay data frame. Since in UHR, devices may support multi-link communication functionality, each link can serve as a relay link, and the maximum or minimum rate on each link may vary. Therefore, the transmission delay on each link is also different. To ensure the transmission delay of UHR services, the relay can select a Link with a better transmission rate as the Relay Link. For example, the transmitter can select the Link with the highest maximum rate value as the Relay Link; or select the Link with the highest minimum rate value as the Relay Link.

In addition, the transmitter can also request multiple first links simultaneously, i.e., set the first identification information of multiple links as the first parameter value, such that the relay can select a target link to transmit the relay data frame. It can be understood that the relay can select the target link as the relay link from multiple first links, or the relay may not select from the first links. For example, if the relay discovers a link with a higher transmission rate, the relay can prioritize selecting the link with the higher transmission rate as the relay link, which can improve the transmission rate and reduce the transmission delay.

The embodiments of the present disclosure provide a communication method, which can be optionally performed by the relay. The method may include the following steps:
receiving a second radio frame transmitted by a relay; where the second radio frame includes second identification information, where the second identification information is set as a second parameter value to identify that the relay transmits the relay data frame in a second link. The second radio frame includes a link present indicator;
where the link present indicator indicates that the second radio frame includes the second identification information. The second radio frame includes a link present indicator, where the link present indicator indicates whether the second identification information (such as the Link Bitmap Present flag) is included in the second radio frame. The Link Bitmap Present flag being set to 1 indicates the presence of the first identification information (such as the Link Bitmap flag) in the second radio frame, to identify that the relay determines the second link as the Relay Link.

The embodiments of the present disclosure provide a communication method, which can be optionally performed by the relay. The method may include the following steps:
determining a fourth radio frame; where the fourth radio frame includes fourth identification information, where the fourth identification information identifies that the relay supports relay data frame transmission; and transmitting the fourth radio frame.

The fourth radio frame can be a Beacon frame, a Probe Response frame, or a Probe Request frame. The relay includes fourth identification information in the fourth radio frame to indicate that the transmitter supports transmitting relay data frames in one or more links.

In an optional embodiment, the method further includes: activating a link that supports relay data frame transmission during initial association with the transmitter.

The relay activates the Relay Link during the initial association process with the transmitter. For example, all links established during the initial association process can be used as Relay links and activated, or a link mapped by Traffic Identifier-to-Link (TID-to-Link) can be used as the Relay link.

The embodiments of the present disclosure provide a communication method, which can be optionally performed by the relay. The method may include the following steps:
receiving a first radio frame, where the first radio frame includes first identification information, where the first identification information is set as a first parameter value to identify that a transmitter requests to transmit a relay data frame in a first link.

Optionally, the first radio frame includes a link present indicator;
where the link present indicator indicates whether a link present flag is included in the first radio frame.

Optionally, the first identification information is included in a relay discovery element. Optionally, the relay discovery element includes delay bound requirement.

Optionally, the first radio frame includes a relay link discovery frame.

In some embodiments, the method further includes:
receiving a second radio frame transmitted by a relay; where the second radio frame includes second identification information, where the second identification information is set as a second parameter value to identify that the relay transmits the relay data frame in a second link. Optionally, the second radio frame includes a link present indicator;
where the link present indicator indicates that the second radio frame includes the second identification information.

Optionally, the second radio frame includes a relay link response frame.

In some embodiments, the method further includes:
determining a fourth radio frame; where the fourth radio frame includes fourth identification information, where the fourth identification information identifies that the relay supports relay data frame transmission; and
transmitting the fourth radio frame.

In some embodiments, the method further includes:
activating a link that supports relay data frame transmission during initial association with the transmitter.

In the embodiments of the present disclosure, the relay STA receives the first radio frame to obtain the first identification information included in the first radio frame, where the first identification information is set as a first parameter value to identify that the transmitter requests to transmit a relay data frame in the first link. The embodiments of the present disclosure provide an implementation method for data relay to meet the transmission requirements of UHR.

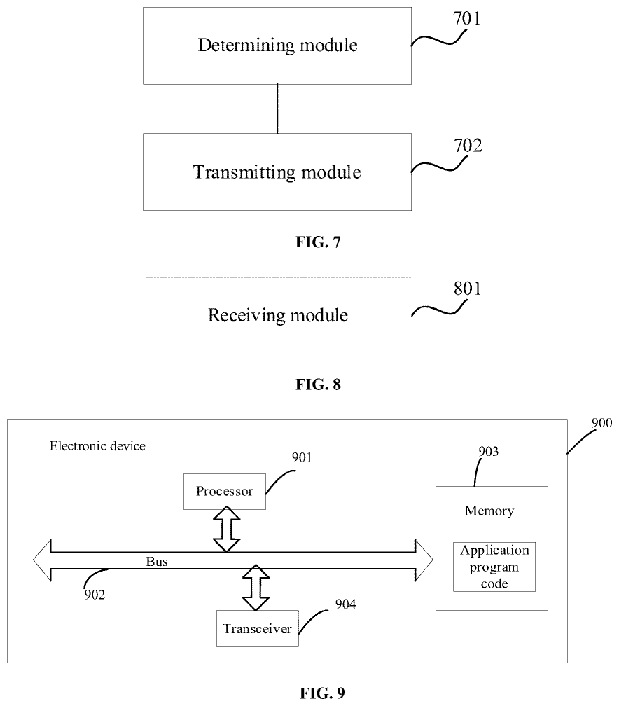

Referring to FIG. 7, based on the same principle as the method provided in the embodiments of the present disclosure, the embodiments of the present disclosure further provide an electronic device, which is a transmitter, including:
a determining module 701, configured to determine a first radio frame, where the first radio frame includes first identification information, where the first identification information is set as a first parameter value to identify that the transmitter requests to transmit a relay data frame in a first link; and
a transmitting module 702, configured to transmit the first radio frame.

Optionally, the first radio frame includes a link present indicator;
where the link present indicator indicates whether the first identification information is included in the first radio frame.

Optionally, the first identification information is included in a relay discovery element. Optionally, the relay discovery element includes delay bound requirement.

Optionally, the first radio frame includes a relay link discovery frame.

Optionally, the electronic device further includes:
a second receiving module, configured to receive a second radio frame transmitted by a relay; where the second radio frame includes second identification information, where the second identification information is set as a second parameter value to identify that the relay transmits the relay data frame in a second link.

Optionally, the second radio frame includes a link present indicator;
where the link present indicator indicates that the second radio frame includes the second identification information.

Optionally, the second radio frame includes a relay link response frame.

Optionally, the electronic device further includes:
a second determining module, configured to determine a third radio frame; where the third radio frame includes third identification information, where the third identification information identifies that the transmitter supports relay data frame transmission; and
The second transmitting module is configured to transmit the third radio frame.

Optionally, the electronic device further includes:
a first activation module, configured to activate a link that supports relay data frame transmission during initial association with a relay.

The embodiments of the present disclosure further provide a communication apparatus, applied to a transmitter, including:
a radio frame determining module, configured to determine a first radio frame, where the first radio frame includes first identification information, where the first identification information is set as a first parameter value to identify that the transmitter requests to transmit a relay data frame in a first link; and
a radio frame transmitting module, configured to transmit the first radio frame.

The apparatus further includes other modules of the electronic device in the previous embodiments, which will not be repeated here.

The embodiments of the present disclosure provide a communication method applied to a wireless transmission system. The wireless transmission system includes a transmitter, a relay, and a receiver. As an example, referring to FIG. 5, where the transmitter (Source STA, S-STA) determines and transmits the first radio frame, where the first radio frame includes first identification information, where the first identification information is set as a first parameter value, indicating that the transmitter requests to transmit a relay data frame in the first link (such as Relay Link in FIG. 5).

After receiving the first radio frame under the first link, the relay obtains the first identification information included in the first radio frame, where the first identification information is set as a first parameter value to identify that the transmitting end requests to transmit a relay data frame under a first link.

Optionally, the first radio frame includes a link present indicator;
where the link present indicator indicates whether the first identification information is included in the first radio frame.

Optionally, the first identification information is included in a relay discovery element.

Optionally, the relay discovery element includes delay bound requirement.

Optionally, the first radio frame includes a relay link discovery frame.

Optionally, the transmitter interacts with the relay for a second radio frame, where the second radio frame includes second identification information, and the second identification information is set as a second parameter value to identify the relay transmitting the relay data frame in the second link.

Optionally, the second radio frame includes a link present indicator;
where the link present indicator indicates that the second radio frame includes the second identification information.

Optionally, the second radio frame includes a relay link response frame.

Optionally, the transmitter interacts with the relay for a third radio frame; where the third radio frame includes third identification information, where the third identification information identifies that the transmitter supports relay data frame transmission; and
transmits the third radio frame.

Optionally, the transmitter activates a link that supports relay data frame transmission during initial association with a relay.

Referring to FIG. 8, based on the same principle as the method provided in the embodiments of the present disclosure, the embodiments of the present disclosure further provide an electronic device, which is a transmitter, including:
a receiving module 801, configured to receive a first radio frame, where the first radio frame includes first identification information, where the first identification information is set as a first parameter value to identify that a transmitter requests to transmit a relay data frame in a first link.

Optionally, the first radio frame includes a link present indicator;
where the link present indicator indicates whether a link present flag is included in the first radio frame.

Optionally, the first identification information is included in a relay discovery element.

Optionally, the relay discovery element includes delay bound requirement.

Optionally, the first radio frame includes a relay link discovery frame.

Optionally, the electronic device further includes:
a second receiving module, configured to receive a second radio frame transmitted by a relay; where the second radio frame includes second identification information, where the second identification information is set as a second parameter value to identify that the relay transmits the relay data frame in a second link.

Optionally, the second radio frame includes a link present indicator;
where the link present indicator indicates that the second radio frame includes the second identification information.

Optionally, the second radio frame includes a relay link response frame.

Optionally, the electronic device further includes:
a third determining module, configured to determine a fourth radio frame; where the fourth radio frame includes fourth identification information, where the fourth identification information identifies that the relay supports relay data frame transmission; and
The third transmitting module is configured to transmit the fourth radio frame.

Optionally, the electronic device further includes:
The second activation module is configured to activate the link that supports the transmission of relay data frames during the initial association with the transmitter.

The embodiments of the present disclosure further provide a communication apparatus, applied to a transmitter, including:
a radio frame receiving module, configured to receive a first radio frame, where the first radio frame includes first identification information, where the first identification information is set as a first parameter value to identify that a transmitter requests to transmit a relay data frame in a first link.

The apparatus further includes other modules of the electronic device in the previous embodiments, which will not be repeated here.

In an optional embodiment, the present disclosure further provides an electronic device, as shown in FIG. 9. The electronic device 900 shown in FIG. 9 can be a server, including a processor 901 and a memory 903. Where processor 901 is connected to memory 903, such as through bus 902. Optionally, electronic device 900 may also include a transceiver 904. It should be noted that in practical applications, the transceiver 904 is not limited to one, and the structure of the electronic device 900 does not constitute a limitation on The embodiments of the present disclosure.

The processor 901 can be a CPU (Central Processing Unit), general-purpose processor, DSP (Digital Signal Processor), ASIC (Application Specific Integrated Circuit), FPGA (Field Programmable Gate Array), or any combination thereof. It can implement or execute various exemplary logical blocks, modules, and circuits described in conjunction with the present disclosure. The processor 901 can also be a combination that implements computing functions, such as a combination containing one or more microprocessors, a combination of DSP and microprocessors, etc.

Bus 902 may include a pathway for transmitting information between the aforementioned components. Bus 902 can be a PCI (Peripheral Component Interconnect) bus or an EISA (Extended Industry Standard Architecture) bus, etc. Bus 902 can be divided into address bus, data bus, control bus, etc. For ease of representation, only one thick line is used in FIG. 9, but it does not indicate that there is only one bus or one type of bus.

The memory 903 can be a ROM (Read Only Memory) or other types of static storage devices that can store static information and instructions, or RAM (Random Access Memory) or other types of dynamic storage devices that can store information and instructions, can also be EEPROM (Electrically Erasable Programmable Read Only Memory), CD-ROM (Compact Disc Read Only Memory) or other optical disc storage, optical disc storage (including compressed optical discs, laser discs, optical discs, digital versatile discs, Blue ray discs, etc.), magnetic disk storage media or other magnetic storage devices, or any other medium that can be used to carry or store desired program code in the form of instructions or data structures and can be accessed by a computer, which is not limited.

The memory 903 is used to store the application program code for executing the disclosed scheme, and is controlled for execution by the processor 901. The processor 901 is used to execute the application program code stored in the memory 903 to implement the content shown in the aforementioned method embodiments.

Where electronic devices include but are not limited to mobile terminals such as mobile phones, laptops, digital broadcast receivers, PDAs (personal digital assistants), PADs (tablets), PMPs (portable multimedia players), car terminals (such as car navigation terminals), and fixed terminals such as digital TVs, desktop computers, and so on. The electronic device shown in FIG. 9 is only an example and should not impose any limitations on the scope of function and use of the embodiments of the present disclosure.

The servers provided in the present disclosure can be independent physical servers, server clusters or distributed systems composed of multiple physical servers, or cloud services, cloud databases, cloud computing, cloud functions, cloud storage, network services, cloud communication, middleware services, domain name services, security services, CDNs, or cloud servers for basic cloud computing services such as big data and artificial intelligence platforms. The terminal can be a smartphone, tablet, laptop, desktop computer, smart speaker, smartwatch, etc., which is not limited. Terminals and servers can be directly or indirectly connected through wired or wireless communication methods, which is not limited in the present disclosure.

The embodiments of the present disclosure provide a computer-readable storage medium on which a computer program is stored, which, when run on a computer, enables the computer to execute the corresponding content of the aforementioned method embodiments.

It should be understood that although the various steps in the flowchart of FIGs. are displayed in sequence according to the arrows, these steps are not necessarily executed in sequence in the order indicated by the arrows. Unless otherwise specified in this article, there is no strict order limit for the execution of these steps, and they can be executed in other orders. Moreover, at least some of the steps in the flowchart of the attached figures may include multiple sub-steps or stages, which are not necessarily completed at the same time, but can be executed at different times. Their execution order is not necessarily sequential, but can be rotated or alternated with at least some of other steps or the sub-steps or stages of other steps.

It should be noted that the computer-readable medium mentioned in the present disclosure can be a computer-readable signal medium, a computer-readable storage medium, or any combination of the two. Computer readable storage media can be, for example but not limited to, systems, devices, or elements of electricity, magnetism, light, electromagnetism, infrared, or semiconductors, or any combination thereof. More specific examples of computer-readable storage media may include, but are not limited to, electrical links with one or more wires, portable computer disks, hard drives, random access memory (RAM), read-only memory (ROM), erasable programmable read-only memory (EPROM or flash memory), fiber optics, portable compact disk read-only memory (CD-ROM), optical storage devices, magnetic storage devices, or any suitable combination thereof. In the present disclosure, a computer-readable storage medium can be any tangible medium containing or storing a program that can be used by an instruction execution system, apparatus, or device, or used in combination with it. In the present disclosure, computer-readable signal media may include data signals propagated in the baseband or as part of a carrier wave, carrying computer-readable program code. This propagated data signal can take various forms, including but not limited to electromagnetic signals, optical signals, or any suitable combination thereof. Computer readable signal media can also be any computer-readable medium other than computer-readable storage media, which can transmit, propagate, or transmit programs for use by or in combination with instruction execution systems, devices, or equipment. The program code contained on a computer-readable medium can be transmitted using any suitable medium, including but not limited to: wires, optical cables, RF (radio frequency), etc., or any suitable combination of the above.

The computer-readable medium mentioned above may be included in the electronic device mentioned above, and can also exist independently without being assembled into the electronic device.

The above-mentioned computer-readable medium stories one or more programs, which, when executed by the electronic device, cause the electronic device to perform the method shown in the above embodiments.

According to one aspect of the present disclosure, there is provided a computer program product or computer program including computer instructions stored in a computer-readable storage medium. The processor of a computer device reads the computer instructions from a computer-readable storage medium, executes the computer instructions, and causes the computer device to perform the methods provided in the various optional implementations mentioned above.

Computer program code for performing the operations in the present disclosure can be written in one or more programming languages or combinations thereof, including object-oriented programming languages such as Java, Smalltalk, C++, or conventional procedural programming languages such as “C” language or similar programming languages. The program code can be completely executed on the user's computer, partially executed on the user's computer, executed as an independent software package, partially executed on the user's computer and partially executed on a remote computer, or completely executed on a remote computer or server. In cases involving remote computers, remote computers can connect to user computers through any type of network, including local area networks (LANs) or wide area networks (WANs), or can connect to external computers (such as using internet service providers to connect via the internet).

The flowchart and block diagram in the attached figures illustrate the possible implementation architecture, functions, and operations of the system, method, and computer program product according to various embodiments of the present disclosure. In this regard, each box in a flowchart or block diagram can represent a portion of a module, program segment, or instruction that contains one or more executable instructions for implementing a specified logical function. It should also be noted that in some alternative implementations, the functions indicated in the box can also occur in a different order than those indicated in the accompanying drawings. For example, two consecutive boxes can actually be executed in basic parallel, and sometimes they can also be executed in opposite order, depending on the functionality involved. It should also be noted that each box in the block diagram and/or flowchart, as well as the combination of boxes in the block diagram and/or flowchart, can be implemented using dedicated hardware based systems that perform specified functions or actions, or can be implemented using a combination of dedicated hardware and computer instructions.

The modules described in the embodiments of the present disclosure can be implemented through software or hardware. Where the name of the module does not constitute a limitation on the module itself in some cases. For example, Module A can also be described as “Module A configured to perform B operations”.

The above description is only a preferred embodiment of the present disclosure and an explanation of the technical principles applied. Those skilled in the art should understand that the scope of the present disclosure referred to in the present disclosure is not limited to technical solutions formed by specific combinations of the above technical features, and should also cover other technical solutions formed by arbitrary combinations of the above technical features or their equivalent features without departing from the above disclosed concept. For example, a technical solution formed by replacing the above features with (but not limited to) technical features with similar functions disclosed in the present disclosure.

1. A communication method, performed by a transmitter, the communication method comprising:
determining a first radio frame, wherein the first radio frame comprises first identification information, wherein the first identification information is set as a first parameter value to identify that the transmitter requests to transmit a relay data frame in a first link; and
transmitting the first radio frame.

2. The communication method according to claim 1, wherein the first radio frame comprises a link present indicator;
wherein the link present indicator indicates whether the first radio frame comprises the first identification information.

3. The communication method according to claim 1, wherein the first identification information is comprised in a relay discovery element.

4. The communication method according to claim 3, wherein the relay discovery element comprises delay bound requirement.

5. The communication method according to claim 1, wherein the first radio frame comprises a relay link discovery frame.

6. The communication method according to claim 1, further comprising:
receiving a second radio frame transmitted by a relay; wherein the second radio frame comprises second identification information; wherein the second identification information is set as a second parameter value to identify that the relay transmits a relay data frame in a second link.

7. The communication method according to claim 6, wherein the second radio frame comprises a link present indicator;
wherein the link present indicator indicates whether the second radio frame comprises the second identification information.

8. The communication method according to claim 6, wherein the second radio frame comprises a relay link response frame.

9. The communication method according to claim 1, further comprising:
determining a third radio frame; wherein the third radio frame comprises third identification information, wherein the third identification information identifies that the transmitter supports relay data frame transmission; and
transmitting the third radio frame.

10. The communication method according to claim 1, further comprising:
activating a link that supports relay data frame transmission during initial association with a relay.

11. A communication method, performed by a relay, the communication method comprising:
receiving a first radio frame, wherein the first radio frame comprises first identification information, wherein the first identification information is set as a first parameter value to identify that a transmitter requests to transmit a relay data frame in a first link.

12. The communication method according to claim 11, wherein the first radio frame comprises a link present indicator;
wherein the link present indicator indicates whether the first radio frame comprises a first indication information.

13. The communication method according to claim 11, wherein the first identification information is comprised in a relay discovery element.

14. The communication method according to claim 13, wherein the relay discovery element comprises delay bound requirement.

15. The communication method according to claim 11, wherein the first radio frame comprises a relay link discovery frame.

16. The communication method according to claim 11, further comprising:
transmitting a second radio frame to the transmitter; wherein the second radio frame comprises second identification information, wherein the second identification information is set as a second parameter value to identify that the relay transmits a relay data frame in a second link;
wherein the second radio frame comprises a link present indicator or a relay link response frame, wherein the link present indicator indicates whether the second radio frame comprises the second identification information.

17.-18. (canceled)

19. The communication method according to claim 11, further comprising:
determining a fourth radio frame; wherein the fourth radio frame comprises fourth identification information, wherein the fourth identification information identifies that the relay supports relay data frame transmission; and
transmitting the fourth radio frame.

20. The communication method according to claim 11, further comprising:
activating a link that supports relay data frame transmission during initial association with the transmitter.

21.-22. (canceled)

23. An electronic device, comprising:
one or more memories that collectively store a computer program; and
one or more processors,
wherein the computer program when collectively executed by the one or more processors cause the electronic device to:
determine a first radio frame, wherein the first radio frame comprises first identification information, wherein the first identification information is set as a first parameter value to identify that a transmitter requests to transmit a relay data frame in a first link; and
transmit the first radio frame.

24. (canceled)

25. An electronic device, comprising:
one or more memories that collectively store a computer program; and
one or more processors,
wherein the computer program when collectively executed by the one or more processors cause the electronic device to act as the relay and perform the method according to claim 11.
